(19) United States
(12) Patent Application Publication
(10) Pub. No.: US 2009/0310451 A1
(43) Pub. Date: Dec. 17, 2009

(54) Recording medium, and a method and apparatus for managing the recording medium

(76) Inventors: Sung Hoon Kim, Seoul (KR); Yong Cheol Park, Seoul (KR)

Correspondence Address: HARNESS, DICKEY & PIERCE, P.L.C., P.O. BOX 8910, RESTON, VA, 20195, US

(21) Appl. No.: 12/227,603

(22) PCT Filed: Jun. 5, 2007
(86) PCT No.: PCT/KR2007/002724

§ 371 Date: Jan. 30, 2009

(30) Foreign Application Priority Data
Jun. 9, 2006 (KR) 10-2006-0052039
Jul. 12, 2007 (KR) 10-2006-0065575

(51) Int. Cl. G11B 20/00

(52) U.S. Cl. 369/47.14; G9B/20

(57) ABSTRACT

A recording medium, and a method and apparatus for manage the recording medium are disclosed.

A method for managing a recording medium including a plurality of recording layers, according to an aspect of the present invention, comprises detecting a defect on a first area of a first recording layer of the recording medium; recording first defect management information for the first area in a management area of the recording medium; and recording, in the management area, second defect management information for a second area of a second recording layer, wherein the second area is in a location physically corresponding to that of the first area.

A method for managing a recording medium, according to another aspect of the present invention, comprises recording a defect list, which includes management information for a defective area of the recording medium, in at least one defect list position contained in a management area of the recording medium; and recording status information indicating a record status of the defect list position.

### FIELD OF THE INVENTION

The present invention relates to a recording medium, and a method and apparatus for recording/reproducing data in/from the recording medium, and more particularly to a method and apparatus for effectively recording/reproducing data in/from the recording medium.

### DISCUSSION OF THE RELATED ART

Generally, there has been widely used an optical disc acting as a recording medium capable of recording a large amount of data therein. Particularly, there has recently been developed a high-density optical recording medium capable of recording/storing high-quality video data and high-quality audio data for a long period of time, for example, a Blu-ray Disc (BD).

The BD based on the next-generation recording medium technique has been considered to be the next-generation optical recording solution capable of storing much more data than a conventional DVD. In recent times, many developers have conducted intensive research into the international standard technical specification associated with the BD along with those of other digital devices.

However, a preferable management method for coping with a defective recording medium (e.g., Blu-ray Disc) for use in the above-mentioned recording/reproducing method has not yet been established, such that many limitations and problems occur in developing a BD-based optical recording/reproducing device.

### SUMMARY OF THE INVENTION

Accordingly, the present invention is directed to a recording medium, and a method and apparatus for recording/reproducing data in/from the recording medium that substantially obviate one or more problems due to limitations and disadvantages of the related art.

An object of the present invention is to provide a recording medium having a structure for managing defects, and a method and apparatus for managing defects of the recording medium.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for managing a recording medium including a plurality of recording layers comprising: detecting a defect on a first area of a first recording layer of the recording medium; recording first defect management information for the first area in a management area of the recording medium; and recording, in the management area, second defect management information for a second area of a second recording layer, wherein the second area is in a location physically corresponding to that of the first area.

The first defect management information may be indicative of information of either a re-allocatable defect (RAD) area or a non-re-allocatable defect (NRD) area.

The second defect management information may be indicative of information of a possibly bad area (PBA).

In another aspect of the present invention, there is provided an apparatus for managing a recording medium equipped with a plurality of record layers comprising: a controller for detecting a defect on a first area of a first recording layer of the recording medium, controlling first defect management information for the first area to be recorded in a management area of the recording medium, and controlling second defect management information for a second area of a second recording layer to be recorded on the management area, wherein the second area is in a location physically corresponding to that of the first area.

The apparatus may further comprise: a recording unit for recording data in the recording medium, wherein the controller controls the recording unit to record the first defect management information and the second defect management information in the management area.

In still another aspect of the present invention, there is provided a recording medium equipped with a plurality of record layers comprising: a recording medium management area including first defect management information for a first area, which includes a defect, of a first layer of a recording medium, wherein the management area includes second defect management information for a second area of a second recording layer, wherein the second area is in a location physically corresponding to that of the first area.

In still another aspect of the present invention, there is provided a recording medium including a management area comprising: the management area including at least one defect list position at which a defect list is stored, wherein the management area further includes status information indicating a record status of the defect list position.

The status information may indicate whether a valid defect list is recorded in the defect list position.

The status information may indicate whether a valid defect list is recorded in the defect list position, an invalid defect list is recorded in the defect list position, dummy data is recorded in the defect list position, or data is not recorded in the defect list position.

In still another aspect of the present invention, there is provided a method for managing a recording medium comprising: reading status information for at least one defect list position from a management area of the recording medium, the status information indicating a record status of the defective list location; determining a position including a valid defect list from among the defect list position based on the read status information; and reading the valid defect list from the determined position.

In still another aspect of the present invention, there is provided an apparatus for managing a recording medium comprising: a controller for checking status information of at least one defect list position from a management area of the recording medium, the status information indicating a record status of the defect list position, determining a position including a valid defect list from among the defect list position based on the checked status information, and reading a defect list from the determined position.

In still another aspect of the present invention, there is provided a method for managing a recording medium comprising: recording a defect list, which includes management information for a defective area of the recording medium, in at least one defect list position contained in a management area of the recording medium; and recording status information indicating a record status of the defect list position.

In still another aspect of the present invention, there is provided an apparatus for managing a recording medium comprising: a controller for controlling a defect list, which includes information of a defective area of the recording medium, to be recorded in at least one defect list position contained in a management area of the recording medium, and controlling status information indicating a record status of the defect list position to be recorded in the management area.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 shows a structure of a recording medium according to an embodiment of the present invention;

FIG. 2 shows the list of defects (i.e., a defect list) according to the present invention;

FIG. 3 is a conceptual diagram illustrating a method for managing a defective area of a disc according to the present invention;

FIG. 4 is a block diagram illustrating an optical recording/reproducing device according to the present invention;

FIG. 5 is a flow chart illustrating a method for recording/reproducing data in/from a recording medium according to the present invention;

FIG. 6 shows a structure of a recording medium according to another embodiment of the present invention;

FIG. 7 shows status information of a defect list according to a first embodiment of the present invention;

FIG. 8 shows status information of a defect list according to a second embodiment of the present invention;

FIG. 9 is a conceptual diagram illustrating a method for allocating status information of a defect list according to the present invention;

FIG. 10 shows a first embodiment of management information recorded in a management area when the recording medium includes four recording layers according to the present invention;

FIG. 11 shows a second embodiment of management information recorded in a management area when the recording medium includes four recording layers, and characteristics of information recorded in each position of the defect list based on the second embodiment;

FIG. 12 shows a third embodiment of management information recorded in a management area when the recording medium includes four recording layers, and characteristics of information recorded in each position of the defect list based on the third embodiment;

FIG. 13 shows a fourth embodiment of management information recorded in a management area when the recording medium includes four recording layers, and characteristics of information recorded in each position of the defect list based on the fourth embodiment;

FIG. 14 is a flow chart illustrating a method for reproducing data from a recording medium according to a embodiment of the present invention; and

FIG. 15 is a flow chart illustrating a method for reproducing data from a recording medium according to another embodiment of the present invention.

### DETAILED DESCRIPTION OF THE INVENTION

Reference will now be made in detail to the embodiments of the present invention, examples of which are illustrated in the accompanying drawings. Wherever possible, the same reference numbers will be used throughout the drawings to refer to the same or like parts.

Prior to describing the present invention, it should be noted that most terms disclosed in the present invention correspond to general terms well known in the art, but some terms that have been selected by the applicant as necessary will hereinafter be disclosed in the following description of the present invention. Therefore, it is preferable that the terms defined by the applicant be understood on the basis of their meanings in the present invention.

A recording medium for use in the present invention is indicative of a data-recorded recording medium or all recordable mediums, for example, an optical disc, and a magnetic tape, etc., according to various recording schemes.

In more detail, a variety of optical discs, for example, a CD, a DVD, a BD, a HD-DVD, and a Near Field Recording (NFR) disc, can be used as the above-mentioned recording mediums.

The term “management area” is indicative of a specific area in which management information of a recording medium is recorded.

A variety of management areas can be allocated to the recording medium. For the convenience of description and better understanding of the present invention, a Disc (or Defect) Management Area (DMA) and a Temporary DMA (TDMA) will hereinafter be exemplarily used as the above-mentioned management area in the present invention. Both the DMA and the TDMA provide defect and/or recording management information for the recording medium.

It should be noted that the recording medium may include any one or all of the DMA and the TDMA according to its categories or format.

In association with the above-mentioned description, the TDMA includes management information of the recording medium before the recording medium is closed or finalized, and the DMA includes final management information of the recording medium when the recording medium is closed.

The defect list (DFL) is indicative of a specific list including management information of the defect generated or detected during the recording/reproducing operation of the recording medium. The defect list may be stored in the management area. For example, the TDMA may store a Temporary DFL (TDFL) including information of defect(s) detected while the recording medium is in use (i.e. before the recording medium is closed), and the DMA may store the defect list including management information associated with defect(s) when the recording medium is closed. The management information stored on the DMA acts as final management information of the recording medium.

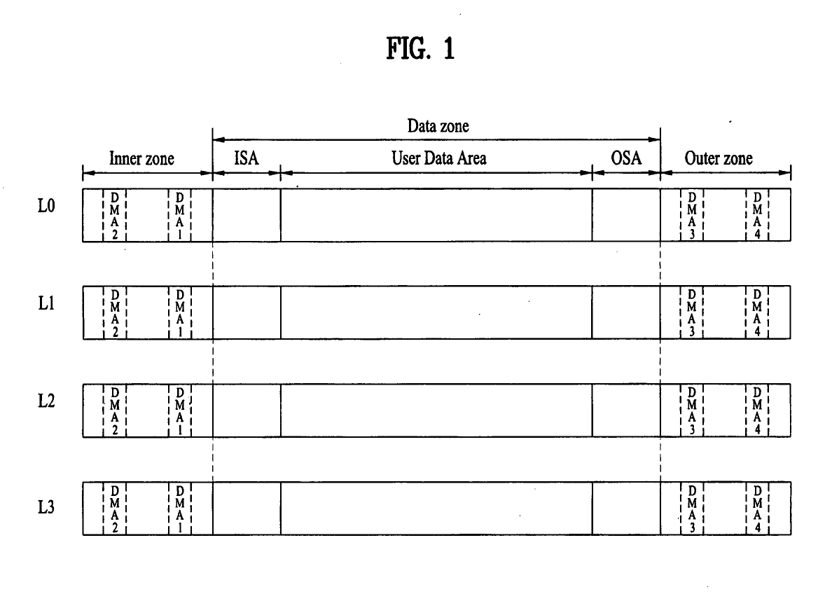

FIG. 1 shows a structure of a recording medium according to an embodiment of the present invention.

For the convenience of description and better understanding of the present invention, a specific disc including four recording layers will hereinafter be used as an example of the present invention, however, it should be noted that the scope and technical fields of the present invention can be applied to all the recording mediums, each of which includes one or more recording layers.

Referring to FIG. 1, from the viewpoint of an inner area of the disc, each of the four recording layers in the disc sequentially includes an inner zone, a data zone, and an outer zone.

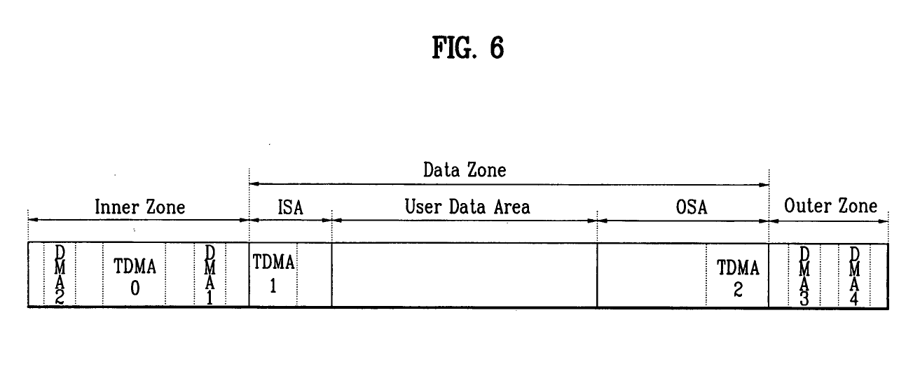

A user data area on which user data is recorded, and an Inner Spare Area (ISA) and an Outer Spare Area (OSA) for managing defect(s) of the disc. However, the above-mentioned spare area may not be assigned to the data zone. The DMA may be assigned to the inner and outer zones. For example, the inner zone of each recording layer may include a DMA2 and a DMA1, and the outer zone of each recording layer may include a DMA3 and a DMA4 as necessary. In association with the above-mentioned description, a write-once disc may further include a TDMA along with the above-mentioned DMAs. In this case, the TDMA stores defect management information created while the disc is in use. A zone or area on which the TDMA is allocated and a detailed relationship between the DMA and the TDMA will be described later with reference to FIG. 6.

In association with the above-mentioned description, the term “defect management information” is indicative of information of defect detected or created during the disc recording/reproducing operation. As stated above, the above-mentioned defect management information may be recorded in the management area.

Particularly, the above-mentioned defect management information may be recorded in the defect list which is stored in the management area. For example, the defect management information may include position information of a defective area (e.g. defective cluster) of the disc, and position information of a replacement area substituting for the defective area. And, the defect management information may include specific information indicating a defect type of the defective area.

A variety of defect types may be used, for example, a RAD (Re-Allocatable (or re-allocated) Defect), a NRD (Non-Re-allocatable Defect) and a PBA (Possibly Bad Area). The RAD type identifies a defective area with a replacement address assigned. The NRD type identifies a defective area without a replacement address assigned for the defective area although the NRD is denoted by the defect. The PBA (Possibly Bad Area) indicates an area on the disc, which might be defective and should be checked on its reliability.

In association with the above-mentioned description, original data on a defect area of the RAD type is recorded in a spare location and/or a replacement (alternative) location, and is classified into a first RAD type and a second RAD type.

Defective area information of the first RAD type is registered in the defect list. Original data on a defective area of the second RAD type data is recorded in an original location (i.e. the defective area), and the replacement location for the defective area is only allocated to the spare area.

For the convenience of description and better understanding of the present invention, the defect management information of the NRD or RAD type will hereinafter be referred to as first defect management information, and the defect management information of the PBA type will hereinafter be referred to as second defect management information.

In association with the above-mentioned description, the defect type may be defined differently from the above-mentioned type according to disc categories.

The defect type of the write-once disc may be classified into a RAD (Re-allocated Defect) type, a CRD (Contiguous Re-allocated Defect) type, and a NRD (Non-Re-allocated Defect) type.

In this case, the RAD type identifies a single defective or overwritten area with a replacement address assigned and original data on the defective area is recorded at the replacement address (i.e., a spare/alternative location). The CRD type identifies contiguous range of defective or overwritten areas (e.g. contiguous range of defective or overwritten clusters) with a contiguous range of replacement addresses assigned and original data on defective or overwritten areas is recorded in the replacement addresses (i.e. the space/alternative location). The NRD type identifies a single defective without a replacement address assigned although the defective is denoted by a defect.

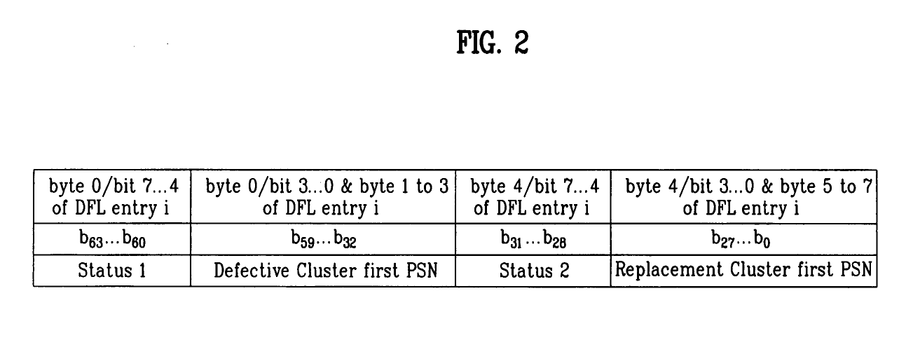

FIG. 2 shows the defect list according to the present invention.

Referring to FIG. 2, the defect list includes the list of information of defects contained in the disc. This defect list may include a defect list (DFL) entry. The above-mentioned DFL entry provides information of the defective area and the replacement area, and identifies types and locations of the individual defects.

In more detail, the DFL entry includes a “Status 1” field for indicating first status information of the entry, a defective cluster first PSN field for indicating the first physical sector number of the cluster to be replaced/indicated, a “Status 2” field for second status information of the entry, and a “Replacement cluster first PSN” field for indicating the first physical sector number of PSN of the cluster replacing the replaced cluster or the length of a possibly bad area.

The defect type according to the “Status 1” field will hereinafter be described in detail.

For example, if the “Status 1” field is set to “0000” (i.e., Status 1=0000), this indicates the first RAD type. If the “Status 1” field is set to “1000” (i.e., Status 1=1000), this indicates the second RAD type. If the “Status 1” field is set to “0010” (i.e., Status 1=0100), this indicates the NRD type. If the “Status 1” field is set to “0100” (i.e., Status 1=0100), this indicates the PBA type. If the “Status 1” field is set to “0111” (i.e., Status 1=0111), this indicates the “Unusable” type. The defect type according to the “Status 2” field will hereinafter be described in detail.

For example, if the “Status 2” field is set to “0000” (i.e., Status 2=0000), this indicates that there is no valid setting in the following settings.

If the “Status 2” field is set to “1000” (i.e., Status 2=1000), this indicates the RAD type in which a replacement address is allocated and part of its content is recorded at the replacement address. It should be noted that the “Status 2” field is meaningful only in case of “Status 1=1000”.

If the “Status 2” field is set to “0100” (i.e., Status 2=0100) and the “Status 1” field is set to “0100”, this indicates that corresponding clusters do not include any relevant user data. If the “Status 2” field is set to “0100” (i.e., Status 2=0100) and the “Status 1” field is set to “0010”, this indicates that corresponding clusters have been previously detected as defective clusters.

In association with the above-mentioned description, if a defect occurs in a recording layer of a disc including a plurality of recording layers, area(s) of which location (position) in the upper and/or lower recording layer(s) physically corresponds to that of the defect of the recording layer may be affected by the defect.

For example, if there is a defect in a traveling path of an optical beam which is perpendicularly incident on the several recording layers of the disc, the optical beam may be dispersed, reflected, or diffracted due to the defect, such that servo controlling for the pickup unit 11 may be affected by the dispersed, reflected, or diffracted optical beam. In addition, due to the defect, data recorded in another recording layer may be incorrectly read or may not be reproduced.

Therefore, if there is a defective area in a high-density disc including several recording layers, the present invention provides an improved method for registering each area placed at the physically corresponding location, which are on the traveling path of the optical beam, as the PBA. The defective areas registered as the PBA are managed according to the result of the PBA certification.

For example, if a defect occurs in a specific recording layer of the disc having several recording layers, the value of “0100” is assigned to the “Status 1” field of the defect list, and the first PSN of the first physical cluster of clusters to be registered as the PBA is recorded in the “Defective Cluster First PSN” field. Since it is not known whether user data is recorded on the remaining recording layers other than the recording layer having the defect, the value of “0000” is set to the “Status 2” field

In the later certification process, the reliability of areas registered as the PBAs is examined, and the areas may be deleted from the defect list according to the certification result or may be added to the defect list as the RAD or NRD type.

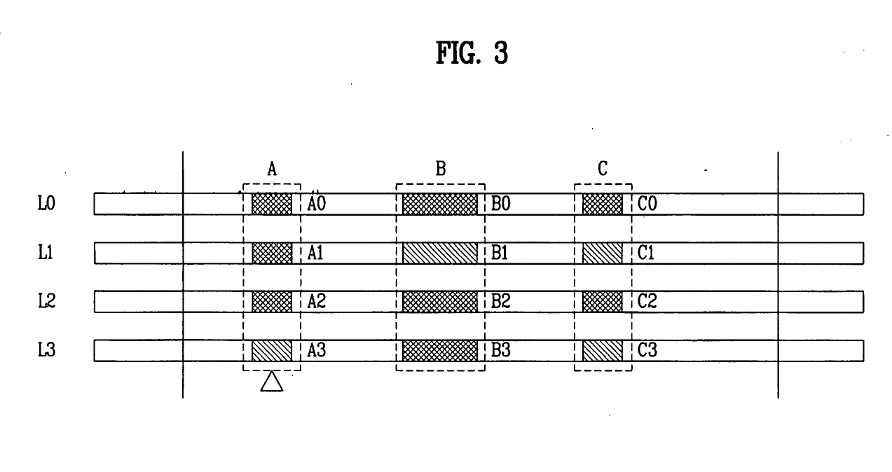

FIG. 3 is a conceptual diagram illustrating a method for managing a defective area of a disc according to the present invention.

For the convenience of description and better understanding of the present invention, it is assumed that a specific recording medium including four recording layers will hereinafter be used as an inventive recording medium of the present invention, however, it should be noted that the scope and spirit of the present invention can also be applied to all the recording mediums, each of which includes a plurality of recording layers.

Referring to FIG. 3, the reference character “A” shows a first embodiment. The first embodiment (A) shows a specific case in which the lowermost recording layer (L3) has a defective area (A3). The first embodiment (A) determines areas (A0, A1, and A2) placed at the location physically corresponding to that of the defective area (A3), on the basis of an optical-beam traveling direction, to be the PBA, such that the PBA is registered in the defect list. The above-mentioned PBA may be registered in cluster units.

Referring to FIG. 3, the reference character “B” shows a second embodiment. The second embodiment (B) shows a specific case in which any one of the remaining recording layers (L0, L1, and L2) other than the lowermost recording layer (L3) has a defective area. Specifically, if the defective area (B) is contained in the recording layer (L0), the second embodiment (B) determines areas (B0, B2, and A3) placed at the location physically corresponding to that of the defective area (B1) to be the PBA, such that the PBA is registered in the defect list.

Referring to FIG. 3, the reference character “C” shows a third embodiment. The third embodiment (C) shows a specific case in which the defect occurs in the physically corresponding areas of several recording layers. In more detail, according to the third embodiment, if there is a defect in the physically corresponding areas of the several layers, area of which location in the other layer physically corresponds to those of the defective areas is determined as the PBA.

Specifically, if the defective area (C3) is contained in the lowermost recording layer (L3) and the defective area (C1) is contained in the recording layer (L1) from among the remaining recording layers other than the lowermost recording layer (L3), the third embodiment (C) determines areas (C0 and C2) placed at the physically corresponding location as that of defective areas (C1 and C3) to be the PBA, such that the PBA is registered in the defect list.

Although the above-mentioned three embodiments have been disclosed as described above, other embodiments may also be easily implemented by those skilled in the art. For example, if the defect occurs in the physically corresponding areas of at least three recording layers in a recording medium including several recording layers, the other embodiment determines areas placed at the location physically corresponding to that of the defective area to be the PBA, and registers the PBA in the defect list of the management area.

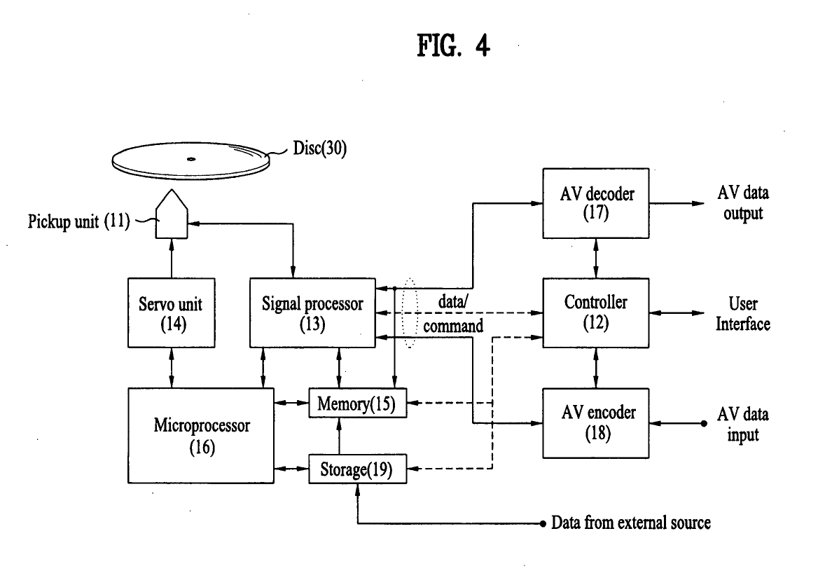

FIG. 4 is a block diagram illustrating an optical recording/reproducing device 10 according to the present invention.

Referring to FIG. 4, the optical recording/reproducing device 10 includes a pickup unit 11, a servo unit 14, a signal processor 13, a memory 15, and a microprocessor 16. The pickup unit 11 reads original data recorded in a disc, and reproduces management information including reproduction management file information. The servo unit 14 controls operations of the pickup unit 11. The signal processor 13 receives a reproduction signal from the pickup unit 11, restores the received reproduction signal to a desired signal format, or modulates a signal to be recorded into another signal recorded in the disc, such that it transmits the recovered or modulated result. The memory 15 stores information needed for recording/reproducing data in/from the disc. The microprocessor 16 controls overall operations of the above-mentioned components contained in the optical recording/reproducing device 10.

In association with the above-mentioned operations, the combination of the above-mentioned components 11, 14, 13, 15, and 16 is also called a recording/reproducing unit 20. From the viewpoint of data reproduction, the recording/reproducing unit reads data from the disc 30 or the storage 19 according to a control signal of the controller 12, and transmits the read data to the decoder. In other words, from the viewpoint of data reproduction, the recording/reproducing unit acts as a playback unit (or a reader) capable of reading data from the disc or storage. From the viewpoint of data recording, the recording/reproducing unit receives the encoded signal from the AV encoder 18, and records video and audio data in the disc 30, such that it serves as a recording unit.

In association with the above-mentioned description, the storage 19 acting as a storage unit may be contained in the recording/reproducing unit 10 or may be connected to the same, such that a user stores desired information or data in the storage 19 and uses the stored information or data at any time. For example, data having persistency may be stored in the storage 19 as necessary. Presently, there are a variety of storages for the recording/reproducing unit 10, for example, a flash memory contained in the recording/reproducing unit 10, a USB memory detachably connected to the recording/reproducing unit 10, an HDD memory, and a memory card.

The storage 19 may act as a storage unit for storing data associated with a recording medium (e.g., BD or HD-DVD). The data associated with the recording medium is generally downloaded from an external device. In association with the above-mentioned description, it will be obvious to those skilled in the art that data is directly read from the recording medium and is then stored in the storage 19.

The controller 12 controls all the constituent components contained in the recording/reproducing unit 10, controls data reproduction of the recording medium via a user interface, and controls the download of data placed at an external part of the recording medium according to a user command.

In association with the above-mentioned description, the controller 12 and the microprocessor 16 may be separated from each other, such that they may be operated independently of each other. Functions of the controller 12 are integrated with those of the microprocessor 16, such that the controller 12 and the microprocessor 16 may be operated by a single control unit. The controller 12 and/or the microprocessor 10 will hereinafter be referred to as a control unit.

For reference, the control unit may be comprised of software (i.e., program) and/or hardware contained in the recording/reproducing unit 10. If the control unit is used as an independent unit, the controller may be called a host, other devices (e.g., the recording/reproducing unit) controlled by the control unit may be called sync devices.

The host and the sync device are connected to each other via an interface unit (not shown), such that control signals are communicated between the host and the sync device. For example, a representative example of the host is a CPU mounted to a personal computer (PC), and other devices controlled by the host may correspond to the above-mentioned sync devices.

The AV decoder 17 receives data from the recording medium and/or the storage 19, finally decodes the received data upon receiving a control signal from the control unit, and transmits the decoded result to the user. The AV decoder 17 may be comprised of several decoders according to data categories.

The AV encoder 18 converts an input signal into a specific format signal (e.g., an MPEG2 transport stream) upon receiving a control signal from the control unit, and transmits the converted result to the signal processor 13, such that it can record a desired signal in the optical disc.

According to the present invention, the control unit determines whether the defective area is contained in at least one recording layer of a recording medium.

If it is determined that there is the defective area in the recording medium, the control unit records first defect management information for the defective area in a management area. And, the control unit records second defect management information for the physically same (corresponding) location as that of the above-mentioned defective area in the management area.

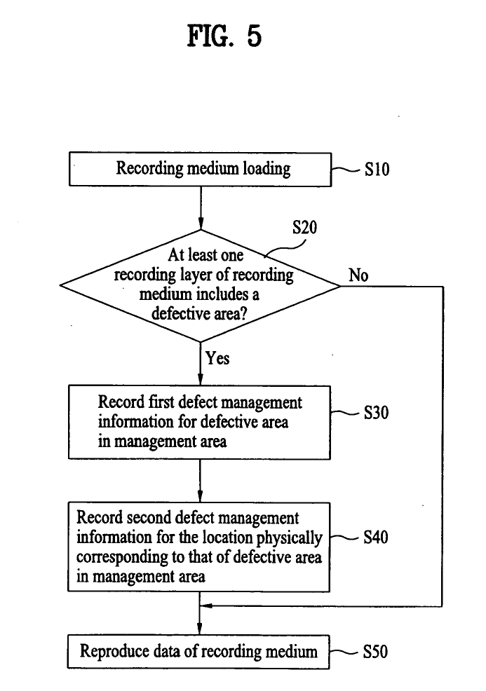

FIG. 5 is a flow chart illustrating a method for recording/reproducing data in/from a recording medium according to the present invention.

Referring to FIG. 5, if a recording medium including at least one recording layer is loaded in the recording/reproducing unit at step S10, the recording/reproducing unit determines whether at least one recording layer of the recording medium includes the defective area at step S20. In this case, only one recording layer among several recording layers may include the defective area, or several recording layers may also includes the defective area.

If it is determined that a defective area is contained in at least one recording layer of the recording medium at step S20, the control unit creates and records management information for the defective area as first management information in a management area of the recording medium at step S30. And, the control unit also creates and records management information for an area(s), placed at the physically same location as that of the defective area, in the other recording layer(s), as second defect management information at step S40.

For example, the defective area is registered as RAD or NRD in the management area, area(s), placed at the physically same location as that of the defective area, in the other recording layer(s) will be registered as the PBA in the management area.

In association with the above-mentioned description, if it is determined that no defect is contained in all the recording layers of the recording medium at step S20, the control unit records data currently being recorded in the recording medium. And, if it is determined that no defect is contained in all the recording layers of the recording medium at step S20, data currently being reproduced is continuously reproduced at step S50.

The first defect management information and the second defect management information may be recorded in the form of a defect list on the management area. The reliability of areas indicated by the first and second defect management information is examined during the certification of the recording medium.

In association with the above-mentioned description, if the areas registered as the PBA are determined to be defective in the certification process, the above-mentioned areas which are determined as defective in the certification process is added as the RAD or NRD in the defect list. In other words, management information thee above-mentioned areas is recorded as the first defect management information in the management area. On the other hand, if the PBA-registered areas are determined to be non-defective in the certification process, management information for the PBA-registered areas is removed from the defect list. In details, the second defect management information for area placed at a location physically corresponding to that of a defective area.

As described above, if a recording layer of the recording medium including a plurality of recording layers has a defective area, the present invention registers the area of which location in the upper and/or lower recording layer(s) of the defective recording layer corresponds to that of the defective area, as the defectable area, thereby protecting data from the defect.

Therefore, in the case where data is recorded in the recording medium or data of the recording medium is reproduced using the method for managing a high-density disc including several recording layers according to the present invention, the present invention can improve the reliability of data.

FIG. 6 shows a structure of a recording medium according to another embodiment of the present invention.

Referring to FIG. 6, in addition to the DMA, the TDMA is further allocated to the recording medium. Although the present invention will hereinafter be described as an example of a single layer composed of only one recording layer, it will be obvious to those skilled in the art that the spirit and scope of the present invention can also be applied to other recording medium including several recording layers.

As described above, the recording medium according to the present invention may include the DMA and the TDMA according to its categories. In association with the above-mentioned description, the TDMA is generally classified into two kinds of TDMAs, i.e., a TDMA0 and additional TDMA(s). In more detail, the TDMA0 having a fixed size (e.g., 2048 clusters) is always allocated to the outer zone of the disc when the disc is initialized. As necessary, the additional TDMA(s) may be additionally allocated to update much more defect or recording management information.

The allocation of the above-mentioned additional TDMA(s) is optional, and the additional TDMA(s) may be allocated to the spare area contained in the data zone of each recording layer.

In more detail, each TDMA includes a TDDS (Temporary Disc Definition Structure), a TDFL (Temporary Defect List), and record status information of the data zone.

If a current recording mode is determined to be a sequential recording mode, SRRI (Sequential Recording Range Information) is recorded as the above-mentioned record status information in the TDMA. If a current recording mode is determined to be a random recording mode, a SBM (Space Bit Maps) is recorded as the above-mentioned record status information in the TDMA.

The TDDS includes information about the format and status of the recording medium, such as the size of the spare area or the TDMAs. The TDFL includes information about a defective cluster and a replacement cluster thereof as long as the recording medium has not been closed.

The relationship between the TDMA and the DMA is as follows.

The write-once recordable disc is unable to record data in the same area several times, such that not only defect management information detected or created while the disc is in use but also general management information indicating a disc record status are mixed in the TDMA of the write-once recordable disc.

In other words, the TDMA is used to update the defect management information and the record management information of the disc before the disc is closed. Thereafter, if the disc is closed, no more data can be recorded in a corresponding disc, such that the latest management information contained in the TDMA is transferred (copied) into the DMA. In other words, when closing the disc, the latest management information in the TDMA is recorded as the final management information on the DMA.

Therefore, if the optical recording/reproducing device 10 determines that the disc is not closed, it records/reproduces data in/from the disc using the information recorded in the TDMA. While the disc is used, management information is recorded in the TDMA. If the disc is closed, the latest management information contained in the TDMA is recorded on the DMA as the final management information. Then, the optical recording/reproducing device reproduces data of a corresponding disc using the final management information contained in the DMA.

Referring to FIG. 1, each inner zone of each of four recording layers (L0, L1, L2, and L3) includes a DMA2 and a DMA1, and each outer zone thereof includes a DMA3 and a DMA4.

If the DMA1 is composed of 32 clusters, the overall DMA1 contained in the recording medium of FIG. 1 include 128 clusters. When the disc including the TDMA is closed, the latest management information recorded in the TDMA is recorded on the above four DMAs contained in the disc. The transferred management information is used as the final management information of the disc.

The TDMA0 includes an access indicator indicating a TDMA which is currently in use. For example, provided that TDMA0, TDMA1, and TDMA2 are allocated to the disc, and only the TDMA1 from among the above-mentioned TDMAs is now being used, an access indicator area associated with the TDMA1 will be used. If the disc is closed, the access indicator area associated with the DMA of the above-mentioned disc will be used to indicate that the disc has been closed.

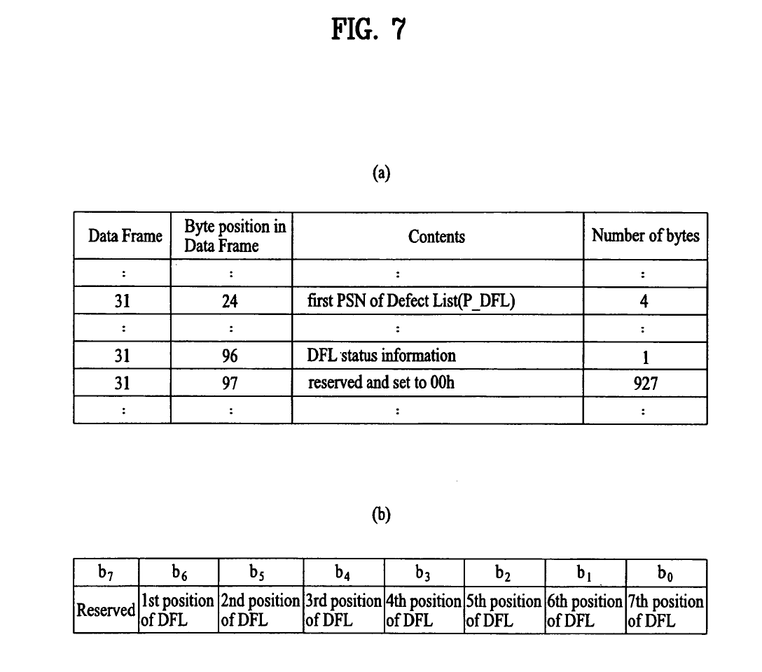

FIG. 7 shows status information of the defect list according to a first embodiment of the present invention.

For the convenience of description, although the first embodiment of the present invention will hereinafter be described using the disc definition structure recorded in the DMA as an example, it should be noted that the present invention can also be equally applied to other disc definition structures recorded in the TDMA.

A disc definition structure (DDS) and a defect list (DFL) are recorded in the DMA. The DDS is repeatedly recorded in some parts of the DMA. The DFL is recorded in the remaining DMA area having no DDS. The remaining DMA area can be divided into several sub-areas (e.g., seven sub-areas). The DFL can be repeatedly recorded in each sub-area, or dummy data (“00h” user information) can be recorded in each sub-area. If necessary, the sub-area may exist as an empty area having no data.

For the convenience of description, the above-mentioned sub-area of the DMA will hereinafter be referred to as a “position of DFL” (also called a “DFL position”). For example, if the remaining DMA area is divided into seven sub-areas, the DMA includes seven DFL positions.

Although a specific case in which the DMA includes 7 DFL positions will hereinafter be described as an example of the present invention, it should be noted that the number of DFL positions contained in the single DMA is not always limited to “7”, and can also be set to other numbers according to category-, version-, and capacity-information of the disc.

FIG. 7(A) partially shows a disc definition structure (DDS). Specifically, if a data frame is set to “31” as shown in FIG. 7(A), a byte position in the data frame, contents of the byte position, and the number of bytes of the contents are included in the DDS.

The byte position in the data frame of the DDS includes position information of a defect list (DFL). The term “DFL position information” according to the present invention is indicative of specific information indicating the position of the DFL recorded in the management area.

Although the above-mentioned DFL position information will hereinafter be described using a DFL's first PSN (i.e., “P_DFL” in FIG. 7) as an example of the present invention, it will be obvious to those skilled in the art that the above-mentioned position information is not limited to only the first PSN of the DFL, and can be applied to other examples as necessary.

The above-mentioned “DFL first PSN” indicates the first DFL position including a valid defect list (DFL) in a DMA having the corresponding DDS. The first PSN information may be represented by 4 bytes.

However, the first PSN information does not include specific information indicating which information has been recorded at the first DFL position. If the DFL is recorded at the position having no defect (i.e., no-defect position), the first PSN of the above area is set in the first PSN field of the DFL, and a defect occurs in the above area in the future, it is difficult to find the next position including a valid DFL using only the first PSN information.

Therefore, the present invention records DFL status information in a corresponding DMA, such that it can indicate which one of information is recorded in the DFL position.

The term “DFL status information” according to the present invention indicates status information of a DFL recorded in a corresponding DFL position or record status information of the corresponding DFL position. For example, the DFL status information may be specific information capable of indicating whether a valid DFL has been recorded at the DFL position.

Referring to FIG. 7(a), the DFL status information may be included in the DDS. For example, a byte position “96” in the data frame of the DDS may indicate the above-mentioned DFL status information.

FIG. 7(b) shows the DFL status information of FIG. 7(a) represented by bits. If the DFL status information is represented by bits, it should be noted that the above-mentioned bit-format DFL status information will hereinafter be referred to as a bitmap in the present invention.

Referring to FIG. 7(b), one bit (i.e., 1 bit) is allocated to each DFL position contained in the DMA, and each allocated bit indicates whether a valid DFL is recorded at each DFL position.

If seven DFL positions are allocated on the DMA, for example, the DFL status information can be represented by a DFL bitmap having a 1-byte size.

In this case, a bit “b0” from among the 1 byte indicating the DFL status information may correspond to status information for the “7^{th} position of DFL”, a bit “b1” from among the 1 byte may correspond to status information for the “6^{th} position of DFL”, a bit “b2” may correspond to status information for the “5^{th} position of DFL”, a bit “b3” may correspond to status information for the “4^{th} position of DFL”, a bit “b4” may correspond to status information for the “3^{rd} position of DFL”, a bit “b5” may correspond to status information for the “2^{nd} position of DFL”, and a bit “b6” may correspond to status information for the “1^{st} position of DFL”. Besides, the bit “b7” is a reserved area.

For example, a corresponding bit of the position including the valid DFL is set to “1b”, a position including an invalid DFL is set to “0b”, a position including “00h user information” is set to “0b”, and a position having no data is set to “0b”, such that DFL status information of each DFL position can be represented. In association with the above-mentioned description, the DFL status information denoted by the individual bits is shown as an example of the present invention, and the order of the individual bits allocated for individual DFL positions may be opposite to that of the above-mentioned description. For example, the bit “b7” may include “1^{st} position DFL” status information as necessary.

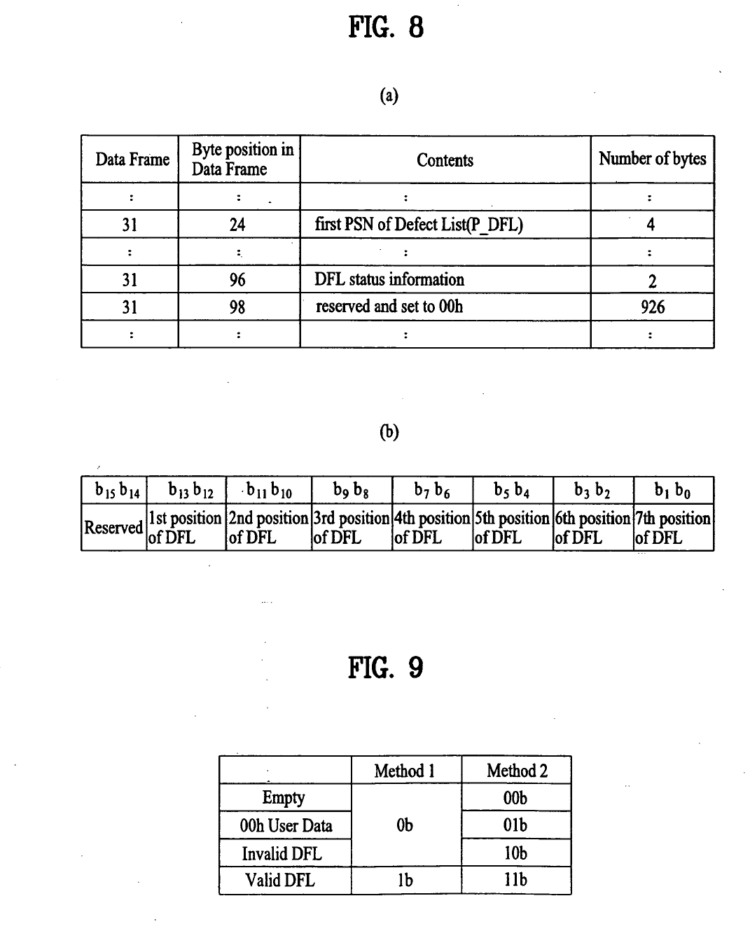

FIG. 8 shows status information of the defect list according to a second embodiment of the present invention. In more detail, FIG. 8(a) shows a specific case in which DFL status information is contained in the DDS in the same manner as in FIG. 7(a), however, the DFL status information of FIG. 8(a) is represented by 2 bytes, differently from FIG. 7(a). FIG. 8(b) shows a specific case in which DFL status information of FIG. 8(a) is represented by bits.

For example, 2 bits are allocated to each DFL position contained in the DMA. By the above-mentioned 2 allocated bits, the present invention indicates whether a valid DFL has been recorded at each DFL position, indicates whether an invalid DFL has been recorded at the DFL position, indicates whether “00h user data” has been recorded, or indicates whether a corresponding area is an empty area having no data.

For example, a bit “b1b0” from among the above 2 bytes indicating the DFL status information may correspond to status information for “7^{th} position of DFL”, a bit “b3b2” may correspond to status information for “6^{th} position of DFL”, a bit “b5b4” may correspond to status information for “5^{th} position of DFL”, a bit “b7b6” may correspond to status information for “4^{th} position of DFL”, a bit “b9b8” may correspond to status information for “3^{rd} position of DFL”, a bit “b11b10” may correspond to status information for “2^{nd} position of DFL”, a bit “b13b12” may correspond to status information for 1^{st} position of DFL”. Besides, the bit “b15b14” is a reserved area. It should be noted that the order of the two bits allocated for the above DFL status information may be opposite to that of the above-mentioned description. The “1^{st} position of DFL” status information may also be contained in the bit “b15b14”.

It should be noted that the above-mentioned DFL status information shown in FIGS. 7 and 8 may be contained in a specific field of the DDS, and the above-mentioned byte positions have been described as an example of the present invention for the convenience of description and better understanding of the present invention.

Therefore, if the above-mentioned DFL status information is contained in the DDS, the byte position of the DFL status information may be changed to another in the DDS data frame as necessary.

FIG. 9 shows embodiments illustrating a method for allocating defect list (DFL) status information according to the present invention.

In this case, the “Method 1” shows an exemplary case in which the DFL status information of each DFL position is represented by 1 bit, and the “Method 2” shows a method for representing the DFL status information by 2 bits.

Referring to the “Method 1”, if the DFL position includes a valid DFL, the DFL status information of the above position is set to “1b”. If the above position includes an invalid DFL or “00h user data”, or has no data therein, the DFL status information may be set to “0”. Needless to say, the meaning of the “1b” may be opposite to that of the “0b” as necessary.

Referring to the “Method 2”, if the DFL position includes a valid DFL, the DFL status information associated with the above position is set to “11b”. If the DFL position includes an invalid DFL, the DFL status information is set to “10b”. If the DFL position includes “00h user data”, the DFL status information is set to “01b”. If the above position has no data such that it remains in empty, the DFL status information is set to “00b”.

Needless to say, the relationship between “11b”, “10b” “01” and “00b” and the DFL status information may also be defined in a different way from the above-mentioned description.

In addition to the “Method 1” and the “Method 2”, another method for representing the “position of valid DFL”, the “position of invalid DFL”, the “position of 00h user data”, and the empty position in the form of bits can also be applied to the present invention.

In association with the above-mentioned description, the number of bytes (or the number of bits) allocated for the DFL status information may be set to different numbers according to the number of allocated DFL positions. For example, if 9 to 16 DFL positions are allocated to the DMA, the “Method 1” may allocate 2 byte for the DFL status information, and the “Method 2” may allocate 4 bytes for the DFL status information.

In association with the above-mentioned description, if a recording mode of a disc is determined to be a sequential recording mode (SRM), management information associated with the disc recording will hereinafter be referred to as a SRRI (Sequential Recording Range Information). If a record mode of a disc is determined to be a random recording mode (RRM), management information associated with the disc recording will hereinafter be referred to as a Space Bit-Map (SBM). The present invention will be described in detail with reference to the above-mentioned disc recording modes.

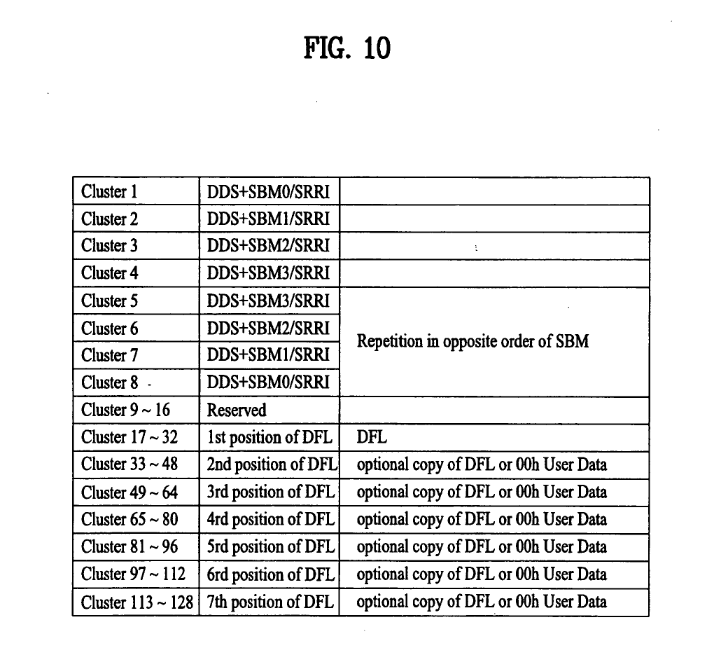

FIG. 10 shows a first embodiment of management information recorded in a management area when the recording medium includes four recording layers according to the present invention.

Referring to FIG. 10, the “cluster 1” includes DDS+SBM0/SRRI, the “cluster 2” includes DDS+SBM1/SRRI, the “cluster 3” includes DDS+SBM2/SRRI, and the “cluster 4” includes DDS+SBM3/SRRI. A plurality of clusters from “cluster 5” to “cluster 8” may include the SBM in the opposite order of the clusters 1˜4. In other words, the “cluster 5” includes DDS+SBM3/SRRI, the “cluster 6” includes DDS+SBM2/SRRI, the “cluster 7” includes DDS+SBM1/SRRI, and the “cluster 8” includes DDS+SBM0/SRRI. In this case, it should be noted that the order of the SBM recorded in each cluster is exemplarily used in the present invention, and can also be set to other orders. For another example, 4 clusters from the “cluster 5” to the “cluster 8” may include the same management information as those of the clusters 1˜4 as necessary.

Referring to FIG. 10, the clusters 9˜16 are set to reserved areas. The clusters 17˜32 are indicative of the first position of the DFL (i.e., DFL first position), and the DFL is recorded in the above-mentioned DFL first position. The clusters 33˜48 correspond to the DFL second position. The clusters 49˜64 correspond to the DFL third position. The clusters 65˜80 correspond to the DFL fourth position. The clusters 81˜96 correspond to the DFL fifth position. The clusters 97˜112 correspond to the DFL sixth position. The clusters 113˜128 correspond to the DFL seventh position.

In this case, the DFL may be selectively copied in clusters from the DFL second position to the DFL seventh position, or “00h” user data may be recorded in the above clusters as necessary.

In the case of reproducing data, the recording/reproducing device 10 according to the present invention reads DFL position information (e.g., DFL first PSN (P_DFL) information) from the management information, such that the recording/reproducing device 10 can recognize that the DFL has been recorded at the DFL first position.

Referring to FIG. 4, if data of the loaded disc is formatted or certified, or if a DFL is newly recorded in the DFL position or a new DFL is recorded in the DFL position or an old DFL is deleted, the control unit of the recording/reproducing device 10 according to the present invention can check status of individual DFL positions. The control unit may store or update the DFL status information for the individual DFL positions on the basis of the checked status.

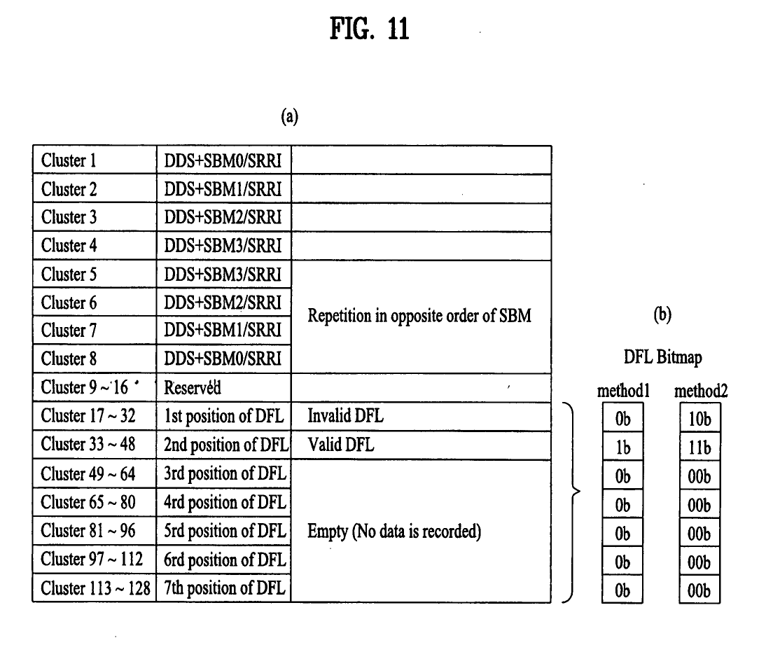

FIG. 11 shows a second embodiment of management information recorded in a management area when the recording medium includes four recording layers, and characteristics of information recorded in each position of the defect list based on the second embodiment.

Referring to FIG. 11(a), a DFL first position includes an invalid DFL, a DFL second position includes a valid DFL, and positions from the DFL third position to the DFL seventh position have no data.

FIG. 11(b) shows characteristics of information recorded at individual DFL positions of FIG. 11(a). Characteristics of information recorded in the DFL positions from the DFL first position to the DFL seventh position are indicated in the DFL bitmap indicating the DFL status information according to the above methods (i.e., Method 1 and Method 2) of FIG. 9.

Referring to FIGS. 11(b) and 10, information characteristics recorded in the above-mentioned DFL positions according to the Method 1 can be represented as follows.

The DFL first position includes an invalid DFL, such that it is set to “0b”. The DFL second position includes a valid DFL, such that it is set to “1b”. DFL positions from the DFL third position to the DFL seventh position are empty areas having no data, such that “0b” can be represented in their DFL bitmaps, respectively.

Information characteristics recorded in the above DFL positions according to the Method 2 can be represented as follows.

The DFL first position includes an invalid DFL, such that it is set to “10b”. The DFL second position includes a valid DFL, such that it is set to “11b”. DFL positions from the DFL third position to the DFL seventh position are empty areas having no data, such that “00b” can be represented in DFL bitmaps, respectively.

For example, in the case of recording the DFL in the DMA, it is assumed that the DFL is recorded in the DFL first position, and DFL first PSN information of the DDS indicates the DFL first position. If the defect occurs in the DFL first position, the recording/reproducing device 10 according to the present invention checks the DFL status information, such that it recognizes that the valid DFL has been recorded in the DFL second position.

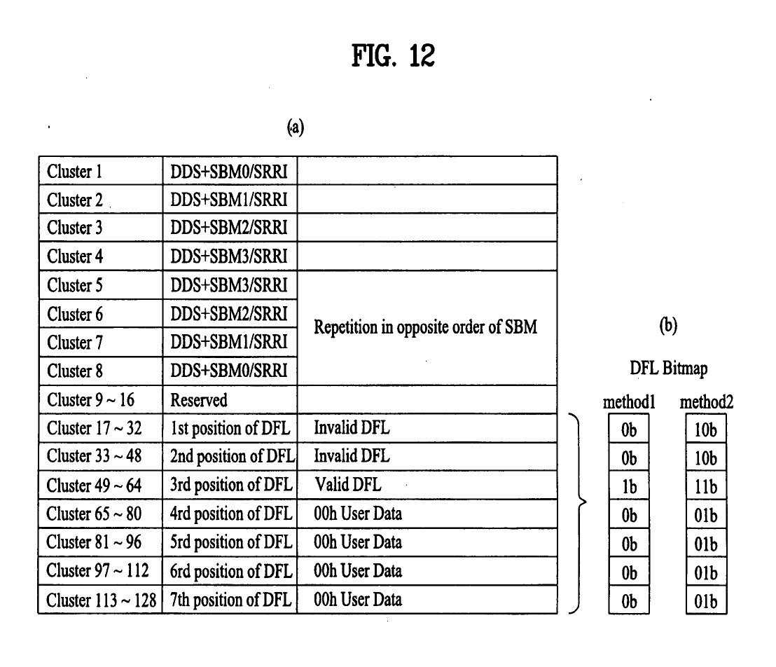

FIG. 12 shows a third embodiment of management information recorded in a management area when the recording medium includes four recording layers, and characteristics of information recorded in each position of the defect list based on the third embodiment.

Referring to FIG. 12(a), the invalid DFL is recorded at the DFL first and second positions, and the valid DFL is recorded at the DFL third position. “00h” user data is recorded in DFL positions from the DFL fourth position to the DFL seventh position.

FIG. 12(b) shows characteristics of information recorded at individual DFL positions of FIG. 12(a). Characteristics of information recorded in the DFL positions from the DFL first position to the DFL seventh position are indicated in the DFL bitmap indicating the DFL status information according to the above methods (i.e., Method 1 and Method 2) of FIG. 9.

Referring to FIGS. 12(b) and 10, information characteristics recorded in the above-mentioned DFL positions according to the Method 1 can be represented as follows.

The DFL first and second positions include invalid DFLs, respectively, such that they are set to “0b”. The DFL third position includes a valid DFL, such that it is set to “1b”. DFL positions from the DFL fourth to the DFL seventh position include “00h” user data, such that “0b” can be represented in DFL bitmaps, respectively. Information characteristics recorded in the above DFL positions according to the Method 2 can be represented as follows.

The DFL first and second positions include invalid DFLs, respectively, such that they are set to “10b”. The DFL third position includes a valid DFL, such that it is set to “11b”. DFL positions from the DFL fourth position to the DFL seventh position are empty areas having no data, such that “00b” can be represented in DFL bitmaps, respectively.

The recording/reproducing device 10 according to the present invention checks the above DFL bitmap (i.e., the DFL status information), such that it can recognize that the DFL position including the valid DFL in the DMA is indicative of the DFL third position.

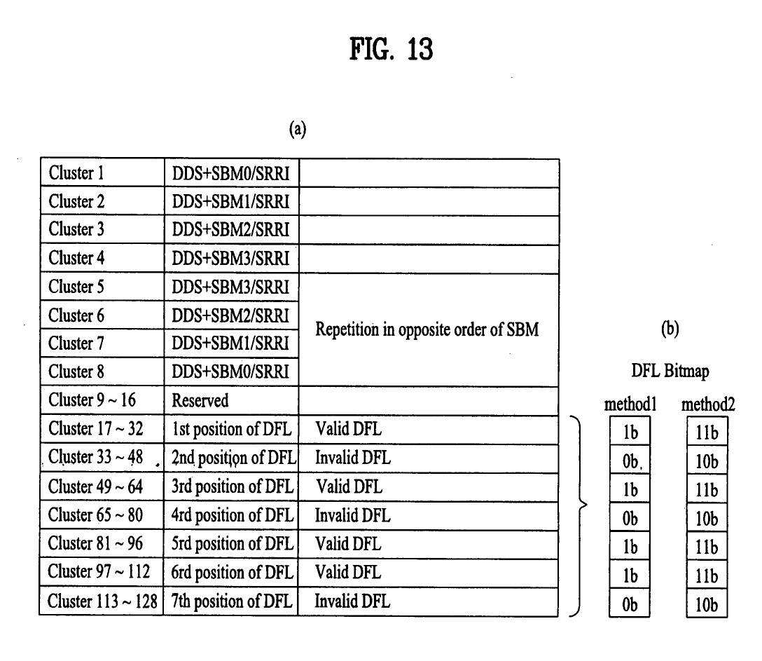

FIG. 13 shows a fourth embodiment of management information recorded in a management area when the recording medium includes four recording layers, and characteristics of information recorded in each position of the defect list based on the fourth embodiment.

Referring to FIGS. 13(a) and 10, the valid DFL is recorded in the DFL first position, the DFL third position, the DFL fifth position, and the DFL sixth position, and an invalid DFL is recorded in the DFL second position, the DFL fourth position, and the DFL seventh position.

FIG. 13(b) shows characteristics of information recorded at individual DFL positions of FIG. 13A. Characteristics of information recorded in the DFL positions from the DFL first position to the DFL seventh position are indicated in the DFL bitmap indicating the DFL status information according to the above methods (i.e., Method 1 and Method 2) of FIG. 9.

Referring to FIGS. 13B and 10, information characteristics recorded in the above-mentioned DFL positions according to the Method 1 can be represented as follows.

The DFL first, third, fifth, and sixth positions include valid DFLs, respectively, such that they are set to “1b”. The DFL second, fourth, and seventh positions include “00h” user data, such that “0b” can be represented in DFL maps, respectively.

Information characteristics recorded in the above DFL positions according to the Method 2 can be represented as follows.

The DFL first, third, fifth, and sixth positions include valid DFLs, respectively, such that they are set to “11b”. The DFL second, fourth, and seventh positions include invalid DFLs, such that “10b” can be represented in DFL maps, respectively.

The recording/reproducing device 10 according to the present invention checks the above DFL bitmap (i.e., the DFL status information), such that it can recognize that the most preceding position including the valid DFL in the DMA is indicative of the DFL first position from Cluster 17 to Cluster 32.

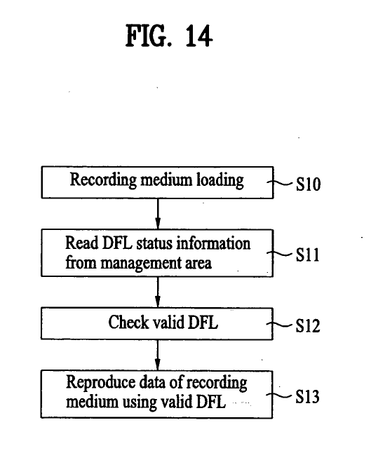

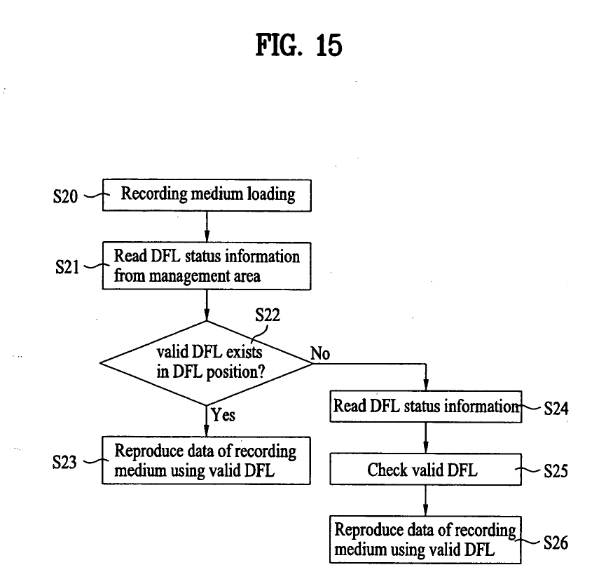

FIG. 14 is a flow chart illustrating a method for reproducing data from a recording medium according to a first embodiment of the present invention.

Referring to FIG. 14, if a recording medium including at least one recording layer is loaded in the recording/reproducing device 10 at step S10, the recording/reproducing device 10 reads the DFL status information from the management area of the recording medium at step S11.

The recording/reproducing device 10 checks a valid DFL using the read DFL status information at step S12, and records/reproduces data in/from the recording medium using the checked valid DFL at step S13.

FIG. 15 is a flow chart illustrating a method for reproducing data from a recording medium according to a second embodiment of the present invention.

Referring to FIG. 15, if a recording medium including at least one recording layer is loaded in the recording/reproducing device 10 at step S20, the recording/reproducing device 10 reads the DFL position information from the management area of the recording medium at step S21. The DFL position information indicates position information of a valid DFL recorded in the management area. The recording/reproducing device 10 determines the presence or absence of the valid DFL in the DFL position indicated by the above DFL position information at step S22.

If it is determined that the valid DFL is recorded in the above indicated DFL position at step S22, the recording/reproducing device 10 reproduces data from the recording medium using the valid DFL recorded in the above indicated DFL position, the recording/reproducing device 10 reproduces data from the recording medium using the valid DFL recorded in the above-mentioned indicated DFL position at step S23.

In the meantime, if it is determined that a DFL contained in the above indicated DFL position is not valid at step S22, the recording/reproducing device 10 reads the DFL status information at step S24. If the DFL status information is checked, the recording/reproducing device 10 can determine a DFL position including a valid DFL from among the above-mentioned management area.

The recording/reproducing device 10 checks the valid DFL recorded in the above DFL position at step S25, such that it records or reproduces data in/from the recording medium at step S26.

As apparent from the above description, the recording/reproducing device 10 according to the present invention can effectively search for the DFL position equipped with a valid DFL in the recording medium, such that it can effectively use the recording medium.

Also, the recording/reproducing device 10 can more precisely determine the position including the DFL using the DFL status information, such that it can effectively reproduce data from the recording medium or can effectively record data in the recording medium.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1-24. (canceled)

25. A method for managing a recording medium including a plurality of recording layers, comprising:
detecting a defect on a first area of a first recording layer of the recording medium;
recording first defect management information for the first area in a management area of the recording medium; and
recording, in the management area, second defect management information for a second area of a second recording layer, wherein the second area is in a location physically corresponding to that of the first area.

26. The method according to claim 25, wherein the second defect management information includes information for every second area above the first recording layer.

27. The method according to claim 25, wherein the second defect management information includes information for every second area under the first recording layer.

28. The method according to claim 25, wherein the first defect management information is indicative of information of either a re-allocatable defect (RAD) area or a non-re-allocatable defect (NRD) area.

29. The method according to claim 25, wherein the second defect management information is indicative of information of a possibly bad area (PBA).

30. The method according to claim 25, wherein the first defect management information and the second defect management information are recorded in a defect list on the management area.

31. The method according to claim 25, wherein:
the first defect management information includes the first physical sector number (PSN) of the first area; and
the second defect management information includes the first physical sector number (PSN) of the second area.

32. An apparatus for managing a recording medium including a plurality of recording layers, comprising:
a controller for detecting a defect on a first area of a first recording layer of the recording medium, controlling first defect management information for the first area to be recorded in a management area of the recording medium, and controlling second defect management information for a second area of a second recording layer to be recorded on the management area, wherein the second area is in a location physically corresponding to that of the first area.

33. The apparatus according to claim 32, further comprising:
a recording unit for recording data in the recording medium,
wherein the controller controls the recording unit to record the first defect management information and the second defect management information in the management area.

34. The apparatus according to claim 32, wherein:
the first defect management information is indicative of information of either a re-allocatable defect (RAD) area or a non-re-allocatable defect (NRD) area.

35. The apparatus according to claim 32, wherein the second defect management information is indicative of information of a possibly bad area (PBA).

36. The method according to claim 32, wherein the second defect management information includes information for every second area above the first recording layer.

37. The method according to claim 32, wherein the second defect management information includes information for every second area under the first recording layer.

38. A recording medium including a plurality of recording layers, comprising:
a recording medium management area including first defect management information for a first area, which includes a defect, of a first layer of a recording medium,
wherein the management area includes second defect management information for a second area of a second recording layer, wherein the second area is in a location physically corresponding to that of the first area.

39. The recording medium according to claim 38, wherein:
the first defect management information is indicative of information of either a re-allocatable defect (RAD) area or a non-re-allocatable defect (NRD) area; and the second defect management information is indicative of information of a possibly bad area (PBA).
